(19) United States
(12) Patent Application Publication
(10) Pub. No.: US 2018/0137645 A1
(43) Pub. Date: May 17, 2018

(54) SYSTEM AND METHOD FOR IDENTIFYING A LOCATION OF A PERSONAL ELECTRONIC DEVICE WITHIN A STRUCTURE

(71) Applicant: TOME, INC., Royal Oak, MI (US)

(72) Inventor: Philip J. DANNE, Royal Oak, MI (US)

(21) Appl. No.: 15/718,499

(22) Filed: Sep. 28, 2017

Related U.S. Application Data
(60) Provisional application No. 62/422,301, filed on Nov. 15, 2016.

(51) Int. Cl. G06T 7/73; G06K 9/62; G06F 17/30

(52) U.S. Cl. CPC G06T 7/73; G06K 9/6202; G01S 19/13; G06F 17/3028; G06F 17/30256

(57) ABSTRACT

The present disclosure relates to a method for identifying a location of a personal electronic device carried and used by a user within a structure, and wherein the personal electronic device has a camera. The method may involve using the camera of the personal electronic device to obtain at least one image of surroundings where the personal electronic device is being used. The method further involves using a processor to perform a comparison of the at least one image with a plurality of differing predetermined features stored in a memory, wherein the memory is accessible by the processor. The method further involves identifying, from the comparison, a specific location within the structure where the personal electronic device is located.

### CROSS-REFERENCE TO RELATED APPLICATIONS

This application claims the benefit of U.S. Provisional Application No. 62/422,301, filed on Nov. 15, 2016. The entire disclosure of the above application is incorporated herein by reference.

### FIELD

The present disclosure relates to systems and methods for identifying a real time location of a personal electronic device within a structure having a plurality of user workspaces or work desks, such as a building, by identifying a variety of different visual features within a field of view of a camera of the device, to thus help track usage of each of the workspaces or work desks.

### BACKGROUND

The statements in this section merely provide background information related to the present disclosure and may not constitute prior art.

Shared workspaces or work desks are becoming more and more common in buildings and shared work areas. A shared workplace is a space that may have a power outlet or docking station where a user can charge a personal electronic device (PED), and where the user can log on to a local area network for communication with a local computing system or to obtain access to the Internet. Often, such workspaces are spread out within a building and may be in two or more distinct buildings on a campus like setting, for example a corporate campus or college campus. In such applications, there is often a strong interest in monitoring the usage of the available workspaces to determine which workspaces are being heavily used and which are being only lightly used. This can help the entity providing the workspaces to more efficiently locate the available workstations to make maximum use of each workstation.

In buildings where the workstations may be relatively closely located, or possibly located on several different floors of a single building, a challenge arises in accurately identifying which workstation a user is using. Simple GPS signals may not work reliably inside of a building because of attenuated signal strength, and especially if the workstations are almost directly above one another on different floors of the same building.

Another challenge is being able to reliably identify which workstation a user is using without the need for complex and expensive additional equipment to be installed on all of the workstations that are available for use.

### SUMMARY

This section provides a general summary of the disclosure, and is not a comprehensive disclosure of its full scope or all of its features.

In one aspect the present disclosure relates to a method for identifying a location of a personal electronic device carried and used by a user within a structure, and wherein the personal electronic device has a camera. The method may comprise using the camera of the personal electronic device to obtain at least one image of surroundings where the personal electronic device is being used. The method may further involve using a processor to perform a comparison of the at least one image with a plurality of differing predetermined features stored in a memory, wherein the memory is accessible by the processor. The method may further include identifying, from the comparison, a specific location within the structure where the personal electronic device is located.

In another aspect the present disclosure relates to a method for identifying a location of a portable personal electronic device carried and used by a user within a structure, and wherein the personal electronic device has a camera. The method may comprise using the camera of the personal electronic device to obtain at least one image of surroundings where the personal electronic device is being used. The method may further involve using a processor to access a look-up table containing a plurality of predetermined features. The plurality of predetermined features may include at least one of a specific color, a window, a light fixture, a patterned wall covering, and a heating/ventilation/air conditioning (HVAC) register. The method may further involve using the processor to use the at least one predetermined feature obtained from the look-up table to perform a comparison of the at least one image with the at least one predetermined feature and, from the performed comparison, to determine a specific location within the structure where the personal electronic device is located.

In still another aspect the present disclosure relates to a system for identifying a location of a personal electronic device carried and used by a user within a structure. The system may comprise a portable personal electronic device used by the user, and a camera operably associated with the portable personal electronic device. The camera may be configured to obtain at least one image of surroundings inside the structure where the personal electronic device is being used. A memory may be included for storing images of a plurality of differing predetermined features present in various locations within the structure. A processor may be included which is configured to perform a comparison of the at least one image with the plurality of differing predetermined features and, from the comparison, to identify a specific location within the structure where the personal electronic device is located.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a high level block diagram of a personal electronic device (PED), in this example a laptop, being used at a workstation, and where the laptop's camera is used to image a field of view around the workstation, and where identification software is included on the laptop for identifying specific features present within an image of the camera's field of view obtained by the camera;

FIG. 2 is a flowchart illustrating one example of various operations that may be performed by the identification software in identifying the exact real time location of the workstation that the user's laptop is located at; and

FIG. 3 is a highly simplified look up table or chart illustrating how various diverse features, when detected as being present in one image, can be used to identify a specific location of the workstation at which the laptop is present.

### DETAILED DESCRIPTION

The following description is merely exemplary in nature and is not intended to limit the present disclosure, application, or uses. It should be understood that throughout the drawings, corresponding reference numerals indicate like or corresponding parts and features.

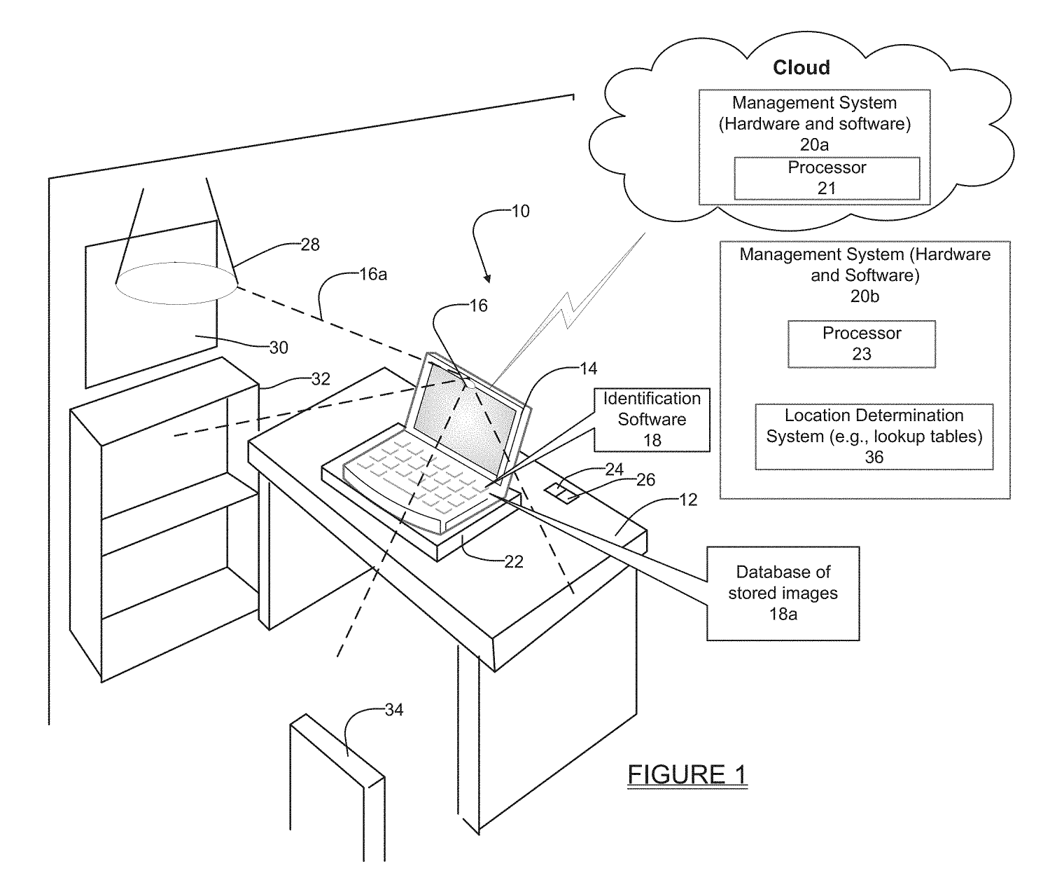

Referring to FIG. 1 there is shown a system 10 for identifying a workstation 12 at which a user's personal electronic device (PED) 14 is present. It will be appreciated immediately that while the PED 14 is illustrated as a laptop computer, and will be referenced throughout the following discussion simply as “laptop 14”, that virtually any type of PED could be used with the system provided it has a camera. Accordingly, smartphones, computing tablets and other similar electronic devices that include a camera could be used just as well with the system 10.

The system 10 makes use a camera 16 of the laptop 14 and identification software 18 loaded onto the laptop. The identification software 18 works in connection with the camera 16 to identify features within a field of view of the camera 16 that enable a management system 20a or 20b to determine exactly which workstation from among a plurality of workstations the laptop 14 is located. This determination may be made in real time or in near real time (i.e., possibly within a few minutes) of the user setting up the laptop 14 and powering it on. Management systems 20a and 20b may be identical in construction or they may be different. Management system 20a is shown located in a Cloud environment and in communication with the laptop 14 via a wide area network (e.g., Internet). connection. Management system 20a may include its own processor 21 (hardware and associated software) for performing a comparison of image features and other processing tasks. Management system 20b may be located at a facility (e.g., building or campus) where the workstation 12 is located and may be in communication with the laptop 14 via a local area network (LAN) connection or even a wide area network connection. Management system 20b may likewise include a processor 23 (hardware and software) for performing image comparison and other processing tasks. It will be appreciated that if management system 20a is included, then management system 20b may not be needed and vice versa. Also, the identification software 18 running in the laptop 14 could be included on either of the management systems 20a or 20b, in which case the camera 16 would simply transmit an image to the management system 20a or 20b and the feature comparisons would be performed by the management system 20a or 20b.

The identification software 18 may be loaded onto the laptop 14 and configured to start automatically when the laptop 14 boots up, or the user may be required to manually start it. It is believed that in most instances it will be preferred that the identification software 18 is configured to start automatically. The laptop 14 may also include a docking station 22 and/or an USB charging port 24 and/or an AC Outlet 26 for charging the laptop 14.

The identification software 18 uses the camera 16 to obtain an image within a field of view of the camera 16, where the field of view is indicated by dashed lines 16a. A portion of the field of view 16a will cover the user seated in front of the laptop 14, as well as other portions surrounding the user (i.e., to the left, right and above the user). The identification software 18 identifies various features within the image such as wall colors, light fixtures 28, windows 30, structures such as bookshelves 32, architectural features such as columns 34 or ledges, patterns such as wainscot wall paneling, wall paper patterns, heating registers, and possibly electrical conduit(s) or HVAC ductwork, just to name a few. Preferably, the features that the identification software 18 is designed to identify are relatively permanent features or fixtures (e.g., windows and architectural features) that are not likely to change over time.

The identification software 18 may use the image obtained via the camera 16 to compare the image to various stored image features (e.g., images of architectural features, images of windows, images of wall covering patterns, images of light fixtures, etc.) in a stored image database 18a to determine when a certain feature is present within the image obtained by the camera 16. The stored image features may be constructed and saved in the stored image database 18a based on known features present within the building (e.g., windows, architectural features, etc.). The stored images may show various features (e.g., windows, light fixtures, etc.) from different angles that would be expected to be encountered based on where the workstations are located within the building or environment.

Once the identification software 18 identifies the various features present within the field of view 28 of the camera 16, the identification software may compare the identified features in the field of view 16a against a lookup table which lists various known features for each different location where the various workstations are located within a building (or buildings) or within some other predefined area. By determining which of the features are present in the field of view 16a of the laptop's camera 16, the identification software 18 may determine the exact location of the laptop 14, for example the specific building, floor of the building, room of the building, and specific workstation within the room, and may transmit this information to the management system 20a or 20b. The management system 20a or 20b may then update a real time log to note that the specific workstation 12 where the laptop 14 is present is currently being used. This information may be used by the management system 20 or 20a to track the usage of a plurality of workstations in a given building or other type of structure or environment.

As noted in FIG. 1, it is also possible that the feature identification comparisons may be performed by separate software and hardware located at either of the management systems 20a or 20b. With such a configuration, the laptop 14 may transmit an image from the camera 16 to the management system 20a or 20b, and the identification software 18 would be located at one or the other of the management systems 20a or 20b. The feature identification would be performed by either one of management systems 20a or 20b. Regardless of which system (laptop 14, management system 20a or system 20b) performs the feature comparisons, the determination of exactly where the laptop 14 is located may be made by the management system 20a or the location determination system 30 of management system 20b through a location determination system 36 that makes use of one or more look-up tables 36.

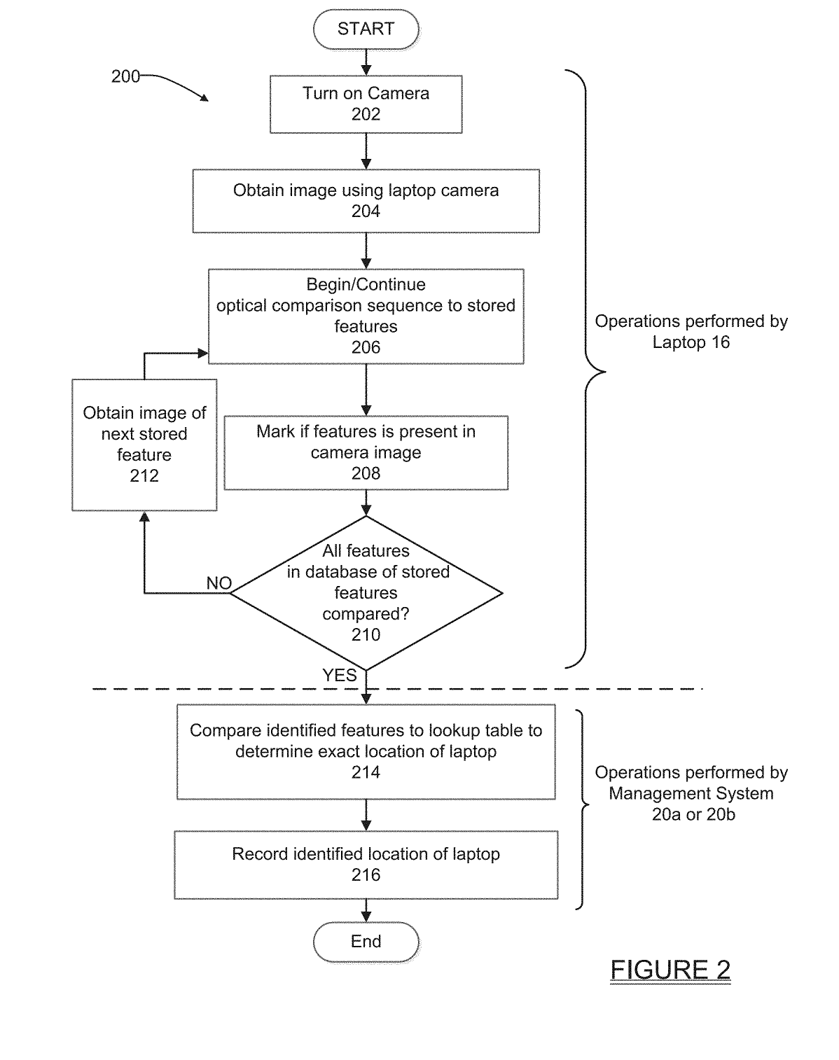

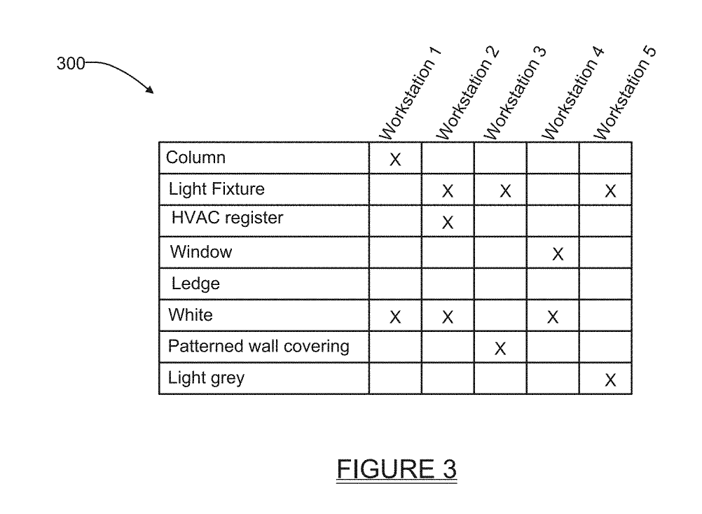

Referring to FIG. 2, a flowchart 200 is shown of various operations that may be performed by the identification software 18 in detecting features within the field of view 16a of the camera 16. Initially the identification software 18 may be configured to start automatically when the laptop 14 is powered on, as indicated at operation 202. The camera 16 is then used to provide an image in accordance with its field of view 16a, as indicated at operation 204. At operation 206 a series of comparisons begins using the image produced by the camera 16, the identification software 18 and the stored image database 18a. Each comparison performed at operation 206 checks the image obtained by the camera 16 against one of the plurality of stored images from the stored image database 18a that shows an image having specific features (e.g., window, architectural column, etc.), and possibly from more than one different angle. If the specific feature is detected, then this event is noted at operation 208. At operation 210 a check is made if all the stored features in the stored image database 18a have been checked, and if not, then at operation 212 an image of the next stored feature is obtained for comparison, and operations 206-210 are repeated. When the check at operation 210 determines that all of the stored features in the stored image database 18a have been checked, then all of the positively identified features are compared against one or more lookup tables of features to determine the exact location of the laptop, as indicated at operation 214. Operation 214 may be performed by either of the management systems 20a or 20b, or even by the laptop 14 if the laptop includes suitable software for this purpose. One such lookup table 300 for use in performing operation 214 is shown by way of example in FIG. 3. The lookup table 300 has an “X” for each feature that is positively correlated with a specific workstation (i.e., specific workstation location). For example, if a light fixture, an HVAC register and a white wall are detected in the image comparisons, then the management system 20a or 20b determines that the laptop 14 is positioned at Workstation 2. A separate look-up table (not shown) may be used to correlate Workstation 2 to a specific location (e.g., specific room of a specific floor of a specific building). It will be appreciated that FIG. 3 represents only a small number of features that could be detected, and that the greater the number of features that are available for comparison purposes, the higher the probability of obtaining an accurate identification of the workstation that the laptop is located.

With further reference to FIG. 2, at operation 216 the identified location of the laptop 14 may be recorded by the management system 20a or 20b. This information could be used to update a real time display of workstation usage that is available to an administrator responsible for monitoring workstation usage. Potentially this information could also be used to provide information to users within a large facility of where available workstations are located, such as by one or more display screens located in common areas of a building or structure.

It will also be appreciated that the system 10 may be configured to obtain “hints” as to where the laptop 14 might be located, such as from inconclusive GPS information, nearby WiFi networks, what hardware monitor device the laptop 14 is connected to, etc. These one or more initial “hints” can be taken into account to make the final attribute search more reasonable, faster and even more reliable. For example, it may be known that weak GPS signals are only receivable at those workstation locations that are adjacent to a window. So the identification software 18 could include a portion that reports any real time GPS information that the laptop 14 has acquired as to its real time location, and if this GPS information is reported, then the identification software 18 will exclude those features that are not present in proximity to any window. Conversely, the identification software may look at only those features that are known to be adjacent to a window. Still further, the system 10 may even use the GPS information to eliminate workstations from consideration that may be in ther buildings where reception of the GPS signal is known to be impossible. Taking into account one or more of the above considerations may significantly simplify and speed up completion of the comparison operations. Such a feature may necessitate the use of one or more additional databases to group specific features in relation to one another (e.g., all features present around the windows of a structure, or all features present in connection with a unique color identified in a scene).

Still further, the time of day and calendar day could be used to further limit the features that would need to be searched. For example, in the month of December at 8:00 p.m., the system 10 may determine that certain features visible through a window will not be present (whereas they otherwise would be present in June), and that the window may appear as a solid black color at 8:00 p.m. in the month of December. This information could be used to eliminate a large number of workstation features from consideration that are known to not be in the same field of view of a window. It would also be possible to use both front and rear facing cameras of PEDs such as computing tablets to obtain even more image information about the surroundings of a given workstation location, and thus even further enhance the accuracy of the system 10 in identifying the exact location of a workstation.

Paint color may be a particularly helpful identifying feature. Even static objects that are outside of the building that the laptop 14 is located in, but still within the field of view 16a of the laptop's camera 16, may be used to help identify the location of a workstation 12.

While various embodiments have been described, those skilled in the art will recognize modifications or variations which might be made without departing from the present disclosure. The examples illustrate the various embodiments and are not intended to limit the present disclosure. Therefore, the description and any claims should be interpreted liberally with only such limitation as is necessary in view of the pertinent prior art.

What is claimed is:

1. A method for identifying a location of a personal electronic device carried and used by a user within a structure, and wherein the personal electronic device has a camera, the method comprising:
using the camera of the personal electronic device to obtain at least one image of surroundings where the personal electronic device is being used;
using a processor to perform a comparison of the at least one image with a plurality of differing predetermined features stored in a memory, wherein the memory is accessible by the processor; and
from the comparison, identifying a specific location within the structure where the personal electronic device is located.

2. The method of claim 1, wherein the differing predetermined features are configured in a look-up table.

3. The method of claim 1, wherein the differing predetermined features include at least one of:
a light fixture;
a heating/ventilation/air conditioning (HVAC) register;
a window;
a ledge;
a color; and
a patterned wall covering.

4. The method of claim 3, wherein the differing predetermined feature includes two or more the light fixture, the HVAC register, the window, the color and the patterned wall covering.

5. The method of claim 1, wherein using a processor to perform a comparison comprises using a processor located within the personal electronic device to perform the comparison.

6. The method of claim 1, wherein using a processor to perform a comparison comprises using a processor located at a remote subsystem to perform the comparison.

7. The method of claim 1, wherein the memory is located at a subsystem remote from the personal electronic device.

8. The method of claim 1, wherein the memory is located in the personal electronic device.

9. The method of claim 1, wherein the processor and the memory are Cloud-based and accessed over a network by the personal electronic device.

10. A method for identifying a location of a personal electronic device carried and used by a user within a structure, and wherein the personal electronic device has a camera, the method comprising:
using the camera of the personal electronic device to obtain at least one image of surroundings where the personal electronic device is being used;
using a processor to access a look-up table containing a plurality of predetermined features including at least one of:
a specific color;
a window;
a light fixture;
a patterned wall covering; and
a heating/ventilation/air conditioning (HVAC) register;
using the processor to use the at least one predetermined feature obtained from the look-up table to perform a comparison of the at least one image with the at least one predetermined feature; and
from the performed comparison, determining a specific location within the structure where the personal electronic device is located.

11. The method of claim 10, wherein using a processor comprises using a processor located within the personal electronic device.

12. The method of claim 10, wherein using a processor comprises using a processor located at a remote management subsystem accessed via a network by a personal electronic device.

13. The method of claim 10, wherein using the processor to access a look-up table comprises using the processor to access a look-up table stored in a memory of the personal electronic device.

14. The method of claim 10, wherein using the processor to access a look-up table comprises using the processor to access a look-up table stored in a memory of a remotely located management system, and wherein the remotely located management system is accessed by the personal electronic device via a network.

15. The method of claim 10, further comprising communicating the specific location of the personal electronic device to a remotely located management subsystem via a network.

16. The method of claim 10, further comprising using global positioning satellite (GPS) information provided by a GPS subsystem of the personal electronic device to assist the processor in determining the specific location.

17. The method of claim 10, further comprising making available the specific location of the personal electronic device to additional users who have entered the structure with additional personal electronic devices.

18. The method of claim 10, further comprising displaying the specific location on at least one display screen available to individuals entering the structure.

19. A system for identifying a location of a personal electronic device carried and used by a user within a structure, the system comprising:
a portable personal electronic device used by the user;
a camera operably associated with the portable personal electronic device configured to obtain at least one image of surroundings inside the structure where the personal electronic device is being used;
a memory for storing images of a plurality of differing predetermined features present in various locations within the structure; and
a processor configured to perform a comparison of the at least one image with the plurality of differing predetermined features and from the comparison, to identify a specific location within the structure where the personal electronic device is located.

20. The system of claim 19, further comprising locating the processor and the memory a remote management subsystem and using the personal electronic device to communicate the at least one image to the remote management subsystem via a network.
